(19) United States
(12) Patent Application Publication
(10) Pub. No.: US 2002/0059413 A1
(43) Pub. Date: May 16, 2002

(54) Method for connecting network element to telecommunication system

(76) Inventors: Jyrki Kaski, Tampere (FI); Ari Nevalainen, Var Eaus (FI); Juha Leino, Tampere (FI); Esa I. Nurmi, Tampere (FI)

Correspondence Address: PILLSBURY WINTHROP LLP, 1600 TYSONS BOULEVARD, MCLEAN, VA, 22102, US

(21) Appl. No.: 09/984,645

(22) Filed: Oct. 30, 2001

Related U.S. Application Data
(63) Continuation of application No. PCT/FI00/00393, filed on May 4, 2000.

(30) Foreign Application Priority Data
May 5, 1999 (FI) 991022

(51) Int. Cl. G06F 15/173

(52) U.S. Cl. 709/223

(57) ABSTRACT

A method for connecting a network element to a telecommunication system comprising at least one network element, one network management system and one telecommunication network for transmitting data between the network element and the network management system. The method comprises creating, in the network management system, a registration service for registering, in the network management system, services comprised in the network elements; storing, in connection with the network element, an identifier of the registration service by means of which a data transmission connection is established from the network element to the registration service. From the network element, a registration message is transmitted to the registration service whereby the network element services are registered in the network management system wherefrom a registration message is transmitted to the network element. The network management services of the network management system are registered in the network element.

This application is a Continuation of International Application PCT/FI00/00393 filed May 4, 2000 which designated the U.S. and was published under PCT Article 21829 in English.

The invention relates to a method for connecting a network element to a network management system of a telecommunication system, which network management system comprises network management services.

The invention further relates to a telecommunication system comprising at least one network element, a network management system and a telecommunication network for transmitting data between the network element and the network management system, which network management system comprises network management services.

The invention further relates to a software product for network management of a telecommunication network.

In large telecommunication networks, the reliability of network operations requires well-functioning network management systems. The network management systems are particularly important in wireless telecommunication networks, such as large mobile networks, which may comprise several thousands of logical network elements. As mobile networks have become increasingly common, the aim has been to enhance the coverage areas and capacity of the networks, which, in turn, results in an increasing number of various network elements.

Connecting new network elements to a telecommunication network and to a network management system typically requires a large amount of data to be transmitted in several different stages between the network element and the network management system before the network element can be completely connected to the network and put to use. In this respect, the network element and the network management system are interactive systems between which a data transmission connection is first established and which require certain data from each other before the configuration may continue. The data to be transmitted comprise e.g. interface specifications, data about services supported both by the network management system and the network element and various internal address data. This requires that the personnel carrying out the installation must have a profound knowledge of the network elements and the structure, identifying system and operation of the telecommunication network.

In certain inherent error situations in the network management or in the network elements the connection between the network management system and the network elements may be disconnected. A situation may then occur wherein at least some of the configuration data comprised in the network element is damaged, which means that as far as the damaged data is concerned, the network element must be re-configured manually in a similar manner to the one used when a new network element is added to a telecommunication network and a network management system.

A problem with the above-described arrangement is the slow and error-prone process for establishing the connection between new network elements and the network management system and for connecting the network element to the telecommunication network. This process has to be carried out each time a new network element is connected to the network. As far as the network operator is concerned, this considerably slows down the enhancement of the capacity and coverage area of the network. A similar problem also caused by the slow process presents itself when a network element is re-configured when configuration data is damaged as a result of e.g. an error situation. It is slow to reconnect the network element to the network, which means that the network capacity and services provided to customers are underutilised for a long time. A further problem is the great amount of knowledge of networks required from the installing staff, which, despite even good training, causes a high probability of error in the configuration process.

An object of the invention is thus to provide a method and apparatus implementing the method so as to enable the above-mentioned problems to be alleviated. The objects of the invention are achieved by a method characterized by

creating, in the network management system, a registration service for registering, in the network management system, the services comprised in the network elements,

storing, in connection with the network element, an identifier identifying said registration service,

establishing a data transmission connection from the network element to said registration service by means of said network identifier,

transmitting from the network element to said registration service a registration message by which the services comprised in the network element are registered in the network management system, and

transmitting from the network management system to the network element a registration message by which the network management services comprised in the network management system are registered in the network element.

A telecommunication system of the invention is characterized in that

the network management services comprise a registration service for registering, in the network management system, the services comprised in the network elements,

a network identifier identifying said registration service is arranged to be stored in connection with the network element,

said network element is arranged to establish a data transmission connection to said registration service by means of said network identifier,

said network element is arranged to transmit to said registration service a registration message by which the services comprised in the network element are registered in the network management system, and

said network management system is arranged to transmit to the network element a registration message by which the network management services comprised in the network management system are registered in the network element.

A software product of the invention is characterized by comprising

means in computer-readable form for storing, in connection of a network element, a network identifier of a register service comprised in a network management system,

means in computer-readable form for establishing a data transmission connection carried out by means of said network identifier to said registration service,

means in computer-readable form for generating and transmitting to the network management system a registration message which identifies the network management services comprised in the network element, and

means in computer-readable form for registering, in connection with the network element, the services comprised in the registration message received from the network management system.

According to a preferred embodiment of the invention, a mediator is arranged to be operatively connected with at least one network element, the mediator being further arranged to establish a data transmission connection between the network element and the network management system. Furthermore, according to a preferred embodiment of the invention, the functionality of the services in a telecommunication system is configured by an object-oriented programming language, whereby according to a preferred embodiment of the invention, the data on the services comprised in the network management system and the network element and/or in the mediator can be transmitted as data transmission according to the CORBA interface specification. Furthermore, according to a preferred embodiment of the invention, a network element, preferably a mediator in connection thereof, is arranged to periodically establish a data transmission connection to the network management system, and when establishing the connection fails, to re-register in the network management system the services comprised in the network element.

The invention is based on the idea that an identifier of a registration service located in a network management system has been determined for a network element, preferably for a mediator in connection thereof, and on the basis of this identifier, the network element, or preferably the mediator, knows how to establish a connection to the registration service comprised in the network management system and registers the services comprised in the network element in the network management system. In response to this, the network management system registers, in the network element, its own services relevant to the network element, whereafter the network element is connected as a controlled part of the telecommunication network.

An advantage of the method and the system of the invention is a fast and reliable process for adding new network elements to network management and telecommunication systems. A further advantage of the invention is a fast and automatic recovery from damage of configuration data of the network element caused by error situations and a resulting breakdown of the connection between the network element and the network management system. A still further advantage of the invention is that the network identifier identifying a registration service is the only piece of data to be permanently stored in the network element, preferably in the mediator thereof, which is necessary for initiating connection setup. Hence, the amount of work required from the installing staff decreases and the process becomes quicker, and the amount of necessary knowledge of networks also decreases. The configuration data is also less likely to become damaged since the amount of permanently stored configuration data is significantly reduced.

The invention is now described in closer detail in connection with preferred embodiments and with reference to the accompanying drawings, in which

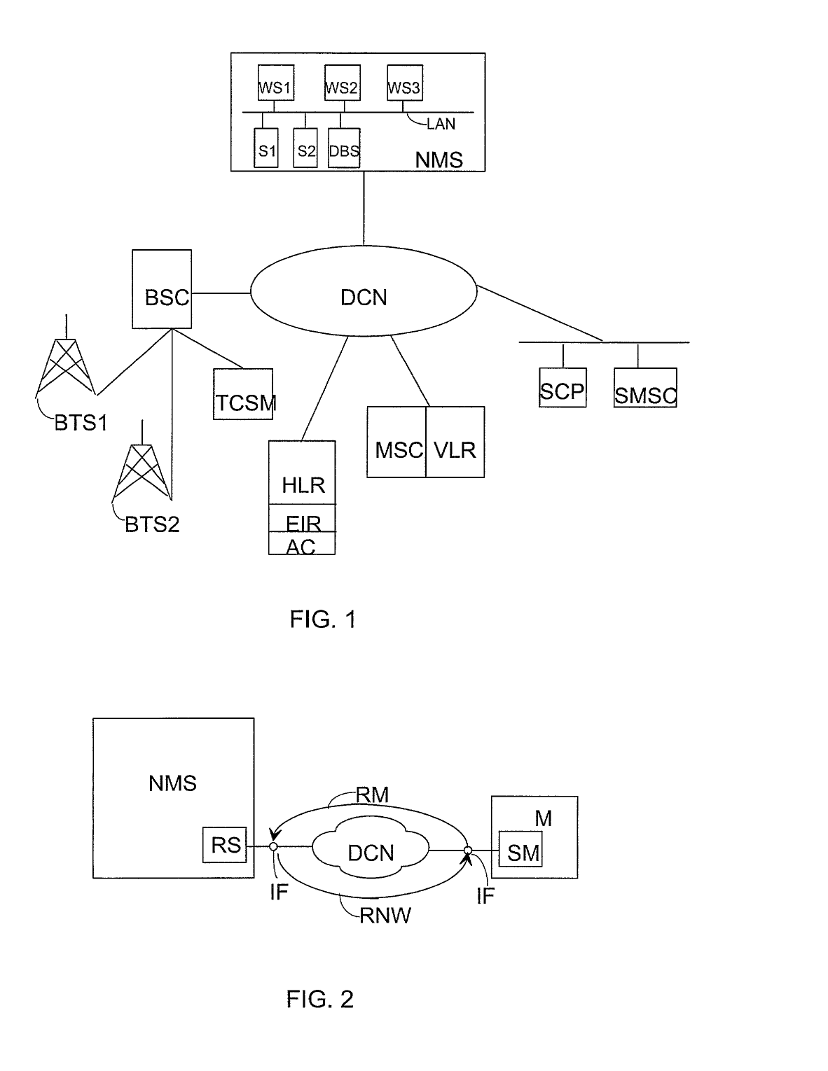

FIG. 1 shows a network management system in a telecommunication network and components in the telecommunication network, and

FIG. 2 shows connection setup of the invention between a network element and a network management system.

Referring to FIG. 1, a typical network management system of a mobile network, a GSM network in particular, will be described in closer detail in the following. The invention is not, however, restricted to wireless telecommunication networks only but the method of the invention can be used in any telecommunication system.

FIG. 1 shows a typical centralised network management system (NMS) connected to various network elements (NE) through a data communication network (DCN). As is known, the data communication network can be implemented in many different ways, for example as a circuit-switched pulse code modulation (PCM) connection, as a packet-switched network or as a local area network according to the OSI model. The network management system is used for controlling and monitoring mobile services switching centres (MSC) and visitor location registers (VLR) in connection thereof, home location registers (HLR), which typically also comprise an equipment identity register (EIR) and an authentication centre (AC), base station controllers (BSC), transcoders&submultiplexers (TCSM) and base transceiver stations (BTS). In addition, the network management system may control network elements which are not actually included in the functions of the mobile network, such as a short message service centre (SMSC) or a service control point (SCP) of an intelligent network. The network management system may control thousands of different network elements. A network management system in itself typically comprises a plurality of servers (S1, S2) and workstations (WS1 to WS3) providing an interface. Typically, at least one server is reserved as a database server (DBS) wherein configuration data of the network elements and alarm and measurement data describing the operation of the network elements can be stored.

It is to be noted that telecommunication networks do not necessarily require a network management system to be centralised, as described above, but the telecommunication networks can also use a decentralised network management system. In such a case, the network comprises several independent network management systems (NMS) which each has an area of responsibility of its own in controlling the network elements. A single network element can also be responsible for the tasks of the network management system in relation to the other network elements. A network management system can thus be seen as an element in the telecommunication network. The method of the invention can also be applied to a decentralised network management system.

In the following, the invention will be described on the basis of FIG. 2. In FIG. 2, a network management system NMS is connected via a data communication network DCN to a mediator M, which is further connected to a plurality of network elements NE1, NE2, . . . The mediator M can be implemented as a separate element, as shown in FIG. 2, whereto one or more network elements are connected. Alternatively, the functionality of the mediator M can be included separately in each network element NE, whereby each network element is directly connected to the network management system NMS via the data communication network DCN. The data communication network DCN is typically implemented as an IP-based (Internet Protocol) network. The mediator M is used to configure an interface IF between the network management system NMS and the network elements NE. The functionality of both the network management system NMS and the network elements NE can be configured by an object-oriented programming language, such as the C++ language. The configured functionalities are then preferably implemented by a computer, a computer referring to any processor that performs a task according to a predetermined program. Program commands fed to the processor are thus in computer-readable form. The use of object-oriented programming languages enables the interface IF to be preferably implemented as a CORBA (Common Object Request Broker Architecture) interface.

CORBA is an industry standard for interconnecting distributed programs. Programs or program components according to the standard can communicate with each other although they were written in different programming languages or operated in different hardware and operating system architectures. CORBA offers services for registration, localisation and activation of components, error processing and parameter transmission. CORBA serves to change the data format between the architectures. CORBA is not a programming method but a common processing mechanism between components provided in different programming languages and hardware.

CORBA is based on client-server architecture where server objects provide client objects with services. Objects can be whole programs or program components. An object can simultaneously both be a server and a client. A client component can call a service using either an interface definition language IDL or by generating a service request dynamically by the services of a dynamic invocation interface DII. IDL is a language used for describing communication interfaces. IDL includes no control structures but only an introduction of the functions and data types of the interface. An IDL specification is converted by an IDL converter, which produces from the specification “stubs” for the client and a “skeleton” for the server. A stub is a function which converts parameters in the presentation form of the client's programming language into a form allowing the parameters to be transferred over the core of CORBA, i.e. object request broker ORB. The client component calls the stub in the same way as its other local functions, and the stub calls a service over the ORB interface. DII is an interface of ORB by means of which the client can call a service although the functions and parameters of the service were unknown when implementing the client. Using DII, the client can search services on the basis of a name or type. On the basis of the interrogation, a service request is dynamically generated which is transmitted to the server by the functions of DII. The server component implements the functions corresponding to its interface and ORB calls them via the skeleton. The calling method used by the client is transparent to the server.

FIG. 2 shows in a simplified manner the configuration of connection setup between the network management system NMS and the network elements NE. Various network management services to enable the exchange of data and signalling data between the network management system NMS and the network elements NE to be controlled have been predetermined in the network management system NMS. These different network management services, such as registration, localisation, activation, error processing and parameter transmission, can preferably be implemented as CORBA services. One such network management service is a registration service RS whose tasks include to enable registration in the network management system NMS of the services comprised in the network elements NE. When a new network element is connected to a network in accordance with the invention, the new network element has to register in the network management system. An object-oriented session manager SM which determines connection setup and which can operate both as a CORBA client and as a CORBA server is implemented in connection with the mediator M. In a corresponding manner, the above-mentioned object-oriented registration service RS, which also supports CORBA, determines registration on the network management system NMS side. The identifier Id of this registration service RS, which is typically a file path address specified with a character string reference, is configured in each mediator M, typically in the session manager SM thereof. The identifier Id of the registration service is preferably the only piece of data to be permanently stored in connection with the network element in order to initiate connection setup between the network management system NMS and the networks elements NE.

The network element NE, preferably the mediator M thereof, initiates the registration of its services by establishing a connection to the network management system NMS, or more specifically, to the registration service RS thereof. The mediator M modifies the identifier Id of the registration service RS according to the form required by CORBA, whereby the mediator M is capable of establishing the connection to the registration service RS. Services are registered each time a new network element is connected to a telecommunication network. Registration can preferably be performed again each time the connection between a network element and a network management system is disconnected. The mediator M generates an RM (Registration Message) which comprises data on all services provided by the network element. The registration message RM is further modified according to the form of the CORBA IDL language to be forwarded via the data communication network DCN to the registration service RS of the network management system NMS.

A registration message RM according to the IDL language can preferably comprise parameters from the mediator M, such as a piece of unambiguously determined identification data and the type of mediator, i.e. what kind of network element the mediator is in connection with. Furthermore, a registration message may comprise specifications concerning the communication between the mediator and the network management system, and the specifications may also concern, for example, connection re-establishment after an error situation. The data on services contained in the network elements comprise titles and identifiers of the services, which can be directly used as a service identifier in the data transmission between the network management system and the network element.

The registration service RS stores received data on the services of the network element in the network management system NMS. Next, the network management system NMS transmits to the mediator M of the network element a message RNW corresponding to the registration message RM wherein the other network management services (in addition to the registration service) of the network management system NMS are registered in the mediator M of the network element. The network management services are specified similarly to the services of the network element, in other words the specifications comprise the titles and identifiers of the services, which can directly be used as a service identifier. When the services of the network management system NMS are registered in the mediator M, the network element NE is connected to the network management system NMS, whereby the network element is ready to be used as a controlled part of the telecommunication network.

The above-described implementation of the invention can be applied to telecommunication systems based on both centralised and decentralised network management. The advantages of the invention are particularly emphasised in decentralised network management where several independent network management systems control their own areas of responsibility but are compelled to distribute a large amount of data on new network elements over the telecommunication network. In such a case, adding new network elements to be controlled by the network management system and recovering from error situations can, according to the invention, occur fast in each network management system covering only a part of the entire telecommunication network.

In accordance with a preferred embodiment of the invention, the mediator M is responsible for connection setup between the network element NE and the network management system NMS after possible error situations. As a result from some error situations, the configuration data of the network element NE may be damaged, whereby according to the prior art the re-configuration and re-connecting to the network of the network element NE should be each time carried out manually. According to this embodiment of the invention, the mediator M detects that the connection between the network element NE and the network management system NMS is disconnected. This can preferably be carried out such that the mediator M is arranged to establish a connection to the network management system at determined intervals whether there is any other data transmission or not between the network element NE and the network management system NMS. If the mediator M is incapable of establishing a connection to the network management system, this is interpreted as an error situation and the mediator M preferably continues to try connection setup to the network management system NMS. The identifier Id of the registration service stored in connection with the mediator enables trying connection setup to the correct address. When the connection is successfully established, the mediator M registers the services of the network element NE by generating the above-described registration message RM, which is further transmitted to the network management system. The services of the network management system are registered in the network element NE also according to the above-described process.

It is obvious to one skilled in the art that as technology advances the basic idea of the invention can be implemented in many ways. The invention and the embodiments thereof are thus not restricted to the above-described examples but can vary within the scope of the attached claims.

1. A method for connecting a network element to a network management system of a telecommunication system, which network management system comprises network management services, the method comprising
creating, in the network management system, a registration service for registering, in the network management system, the services comprised in the network elements,
storing, in connection with the network element, an identifier identifying said registration service,
establishing a data transmission connection from the network element to said registration service by means of said network identifier,
transmitting from the network element to said registration service a registration message by which the services comprised in the network element are registered in the network management system, and
transmitting from the network management system to the network element a registration message by which the network management services comprised in the network management system are registered in the network element.

2. A method as claimed in claim 1, wherein
a data transmission connection is established from at least one network element to the network management system by a mediator.

3. A method as claimed in claim 2, further comprising
configuring the functionality of the services comprised in the network management system and at least in the network elements or in the mediator by an object-oriented programming language, such as the C++ language.

4. A method as claimed in claim 3, further comprising
transmitting data on the services comprised in the network management system and at least in the network elements or in the mediator as data transmission according to the CORBA specification.

5. A method as claimed in claim 4, further comprising
configuring, in connection with the mediator, a session manager according to the CORBA specification which controls connection setup, and
storing said network identifier of the registration service in connection with said session manager.

6. A method as claimed in claim 1, wherein
a data transmission connection is established from said network element to the network management system periodically, and
a data transmission connection is established from said network element to said registration service by means of said network identifier and the services comprised in the network element are re-registered in the network management system, in response to a failure in the periodical data transmission connection setup to the network management system.

7. A telecommunication system comprising at least one network element, one network management system and one telecommunication network for transmitting data between the network element and the network management system, wherein the network management system comprises network management services,
the network management services comprise a registration service for registering, in the network management system, the services comprised in the network elements,
a network identifier identifying said registration service is arranged to be stored in connection with the network element,
said network element is arranged to establish a data transmission connection to said registration service by means of said network identifier,
said network element is arranged to transmit to said registration service a registration message by which the services comprised in the network element are registered in the network management system, and
said network management system is arranged to transmit to the network element a registration message by which the network management services comprised in the network management system are registered in the network element.

8. A telecommunication system as claimed in claim 7, wherein
the telecommunication system comprises at least one mediator arranged to be operatively connected with the network element, which mediator is arranged to establish a data transmission connection from at least one network element to the network management system.

9. A telecommunication system as claimed in claim 8, wherein
the functionality of the services comprised in the network management system and at least in the network elements or in the mediator has been configured by an object-oriented programming language, such as the C++ language.

10. A telecommunication system as claimed in claim 9, wherein
data on the services comprised in the network management system and at least in the network elements or in the mediator are arranged to be transmitted as data transmission according to the CORBA specification.

11. A telecommunication system as claimed in claim 10, wherein
in connection with the mediator, a session manager according to the CORBA specification has been configured to control connection setup, said network identifier of the registration service being stored in connection with the session manager.

12. A telecommunication system as claimed in claim 7, wherein
said network element is arranged to establish a data transmission connection to the network management system periodically, and
said network element is arranged to establish a data transmission connection to said registration service by means of said network identifier and to re-register, in the network management system, the services comprised in the network element in response to a failure in the periodical data transmission connection setup to the network management system.

13. A software product for network management of a telecommunication network, comprising
means in computer-readable form for storing, in connection of a network element, a network identifier of a register service comprised in a network management system,
means in computer-readable form for establishing a data transmission connection carried out by means of said network identifier to said registration service,
means in computer-readable form for generating and transmitting to the network management system a registration message which identifies the network management services comprised in the network element, and
means in computer-readable form for registering, in connection with the network element, the services comprised in the registration message received from the network management system.

14. A software product as claimed in claim 13, wherein
at least some of said means have been configured by an object-oriented programming language, such as the C++ language.

15. A software product as claimed in claim 13, further comprising
means in computer-readable form for periodically establishing a data transmission connection to the network management system, and
means in computer-readable form for establishing a data transmission connection to said registration service by means of said network identifier and for re-registering, in the network management system, the services comprised in the network element in response to a failure in the periodical data transmission connection setup to the network management system.
